(19) United States
(12) Patent Application Publication
(10) Pub. No.: US 2012/0048953 A1
(43) Pub. Date: Mar. 1, 2012

(54) TEMPERATURE ADJUSTING DEVICE AND AN INTELLIGENT TEMPERATURE CONTROL METHOD FOR A SAND AND DUST ENVIRONMENT TESTING SYSTEM

(75) Inventors: Jun Wang, Beijing (CN); Hua Zhang, Beijing (CN); Yunze Li, Beijing (CN); Zhangpeng Ming, Beijing (CN); Keyong Zhu, Beijing (CN); Zhihong Ma, Beijing (CN); Lizhen Zhang, Beijing (CN); Chen Zhao, Beijing (CN)

(73) Assignee: BEIHANG UNIVERSITY, Beijing (CN)

(21) Appl. No.: 13/318,327

(22) PCT Filed: May 20, 2010
(86) PCT No.: PCT/CN10/00720

§ 371 Date: Oct. 31, 2011

(30) Foreign Application Priority Data
Jul. 15, 2009 (CN) 200910089289.8
Jan. 20, 2010 (CN) 201010034360.5

(51) Int. Cl. G05D 23/19

(52) U.S. Cl. 236/51; 219/201

(57) ABSTRACT

A temperature adjusting device is included with a sand and dust environmental testing system. The sand and dust environmental testing system includes: a circulating air duct, including a contraction section, a test section and a separation section etc.; a main blower; U-type separators and guide vanes, respectively configured at four corners of the circulating air duct. The temperature adjusting device includes: heat exchange pipes distributed in the U-type separators; four groups of guide vanes. Three groups of the guide vanes are configured with heat exchange medium holes and the other group of the guide vanes is equipped with heating device. An electric heater is accommodated in the second contraction section. An intelligent temperature control includes: building a neural network system structure; blended learning training of neural network parameters; PI control; and amplitude limitation processing.

### BACKGROUND OF THE INVENTION

1. Technical Field

The present invention relates to a temperature-adjusting device and an intelligent temperature control method for the sand and dust environmental testing systems and belongs to the technical field of sand and dust environmental testing.

2. Description of Related Art

Sand and dust environment is an important environmental factor which has caused the malfunction of many engineering and military hardware, wherein main damage types are erosion, abrasion, corrosion and infiltration etc. The sand and dust blowing test is an important method for inspecting the environmental adaptability and reliability of the vehicles, aircraft, electric and military equipment in the desert & arid areas and under the windy & dusty weather conditions.

The existing sand and dust environmental testing system adopts two air-conditioning boxes, a big one and a small one, to control the temperature, as shown in FIG. 1. The Chinese Invention Patent numbered ZL200510000070.8 discloses a system, wherein, comprising: a circulating air duct 1, a big air-conditioner 2, a small air-conditioner 3, a finned pipe 4 of the surface cooler, a fin-type electric heater 5, a variable-frequency & speed-regulating blower 6, an inlet duct 7 of the big air-conditioner, an inlet duct 8 of the small air-conditioner, a return-air duct 9 of the air-conditioner, a water source 10 of the cold-water unit, a compressed air blow-off duct 11 of the big air-conditioner, and a compressed air blow-off duct 12 of the small air-conditioner. The defects of the system are as follows:

1. With the big air-conditioner 2 and the small air-conditioner 3 for controlling the temperature of the wind tunnel, the system features a more complex structure and more space occupied. The inlet duct 7 of the big air-conditioner, the inlet duct 8 of the small air-conditioner and the return-air duct 9 of the air-conditioner directly intercommunicate with the circulating duct. As a result, the airflow quality in the air duct 1 is influenced by ducts 7, 8 and 9.

2. To realize the temperature control, the circular cooling water and chilled water from the water source 10 of the cold-water unit are used as cooling medium. Moreover, the electric heater 5 and variable-frequency & speed-regulation blower 6 accommodated in the small air-conditioner coordinate with each other to fulfill the temperature-adjusting task under different working conditions and heat loads. The cooling working medium realizes cooling by flowing through the finned pipe 4 of the surface cooler and realizes heating by flowing through the electric heater 5. Since the flowing air contains sand and dust, when passing through the finned pipe 4 of the surface cooler and the fin-type electric heater 5, the dust will accumulate on them and the heat transfer will be influenced. In this way, extra compressed air blow-off ducts 11 and 12 are required, but this causes inconvenience in cleaning.

3. The circulating air duct 1 adopts external heat insulation structure. When conducting a low-temperature test after the implementation of a high-temperature test, a long time is required for cooling the water since the heat transfer area of the surface cooler 4 is limited. Consequently, the utilization efficiency of the test device system is seriously affected.

In addition, in the sand and dust environmental test, the test wind speed and the heat load in the wind tunnel vary greatly and sharply, so the temperature control of the sand and dust environmental test becomes more and more significant. In China, the existing wind tunnel temperature control of the large backwash-type sand and dust environmental tests mainly adopts the method of the configuration of two entirely different temperature control devices, a surface cooler and an electric heater, in the bypass of the air-conditioner. However, this method enlarges the variation range of the temperature difference and increases the control difficulty. At the same time, as the temperature control in the sand and dust environmental test features pure delay, nonlinearity and uncertainty of parameters etc., which may easily cause great vibration and error, the traditional control strategy can hardly meet the index requirements of the performance. Also, the sand and dust environmental wind tunnel test temperature controls differ from the normal temperature controls in their object features and difficulties.

In the circulating air duct, the variation of the rotation speed of the blower and the flow quantity and temperatures of the auxiliary airflow and the environment will cause a temperature disturbance inside the air duct. Through adjusting the heating power of the electric heater and flow quantity of the cooling water, the temperature disturbance can be controlled. However, the heat load difference in the air duct is great, so the adoption of different coordination control measures is required. The elimination of the disturbance caused by the disturbance sources and overcoming the impacts on the temperature control system caused by various nonlinear factors, namely the high-accuracy and high-compatibility temperature control method, is the key technology of the temperature control field.

At present, there are two ideas for solving the temperature control of the sand and dust environmental wind tunnel test: one is using temperature control equipment capable of adjusting the temperature within the normal range within the hardware structure. Although this scheme can improve the temperature control greatly, it increases the cost and complexity of the hardware and has a great restriction on reliability; the other one is a software control method—through model building and a control algorithm, namely through control strategy and learning capacity approaching random, nonlinear mapping capacity, this method can control the temperature in real time and effectively compensate for the error caused by the nonlinear factor, thus influencing its compensation accuracy and ensuring its accuracy and coordination.

### BRIEF SUMMARY OF THE INVENTION

One object of the present invention is to provide a temperature adjusting device and an intelligent temperature control method for the sand and dust environmental wind tunnel test system in order to overcome the following defects existing in the prior art:
1) the air-conditioning device needs a special air-conditioning duct and heat transfer surface and may generate extra operation consumption; moreover, the air-conditioning duct also influences the airflow quality in the circulating air duct;
2) since the airflow in the circulating air duct passing through the surface cooler and the electric heater contains sand and dust, it will cause dust residue to remain which will seriously influence the heat transfer and cause inconvenience in cleaning;
3) realize the temperature control of the airflow in the circulating air duct by means of the separators, guide vanes and contractions section existing in the circulating air duct, and provide a temperature adjusting system featuring compact structure, easy cleaning and high equipment utilization efficiency.

Another object of the present invention is to provide an intelligent temperature-control method for the sand and dust environmental testing system in order to overcome the deficiency existing in the prior art in the aspects of high-accuracy, high-stability and coordination control.

The present invention provides a temperature-adjusting device for the sand and dust environmental testing system, wherein the sand and dust environmental testing system mainly comprises:

a circulating air duct, which is a closed air duct with an irregular structure for providing a place for blowing off the sand and dust; wherein the circulating air duct comprises a second contraction section, a test section and a separation section;

a main blower, used to drive airflow in the circulating air duct;

U-type separators configured on a separation section, used to conduct the separation and recycling of the sand and dust tested; and

guide vanes configured at four corners of the circulating air duct in four groups;

Characterized in that, the temperature-adjusting device comprises:

heat exchange pipes distributed in the U-type separators;

the four groups of guide vanes, wherein three groups of the guide vanes are configured with heat exchange medium holes, the other group of the guide vanes is equipped with a heating device;

an electric heater configured in the second contraction section.

Wherein the temperature-adjusting device further comprises:

a water source of circulating cooling water;

a cold-water unit, and

an electric boiler;

The circulating cooling water source, cold-water unit and electric boiler connect, respectively, with the guide vanes with heat exchange function and the U-type separators through the pipes; valves for adjusting the flow quantity of the cooling and heating medium are configured on each pipe.

Wherein, the heating device configured in the guide vanes is an electric heater which is coated with an insulation layer and a wear-proof protection layer in turn.

An intelligent temperature control method for the sand and dust environmental testing system provided by the present invention is realized through the neural network-based PI intelligent temperature control system, wherein the intelligent temperature control system comprises:

a wind speed sensor accommodated in the circulating air duct;

a temperature sensor accommodated in the circulating air duct;

a neural network controller, which obtains a coordination control factor according to the wind speed value measured by the wind speed sensor to determine which equipment is the main control equipment and which is the auxiliary equipment to fulfill the coordination control adequately, wherein the neural network controller specifically comprises an input layer, a hidden layer and an output layer;

a PI controller, used to receive the coordination control factor from the neural network controller and the temperature value measured by the temperature sensor and transmit the control quantity processed to the temperature control device of the sand and dust environmental testing system.

Wherein, the PI controller comprises:

a first PI controller, used to generate the first rough control quantity, according to the temperature value and the coordination control factor,

a second PI controller, used to generate the second rough control quantity, according to the temperature value and the coordination control factor.

Wherein, the intelligent temperature control system further comprises:

a first amplitude limiter, used to conduct amplitude limitation and optimization processing to the first rough control quantity so as to generate the optimized precise control quantity used by the return-water control valve of the electric boiler,

a second amplitude limiter, used to conduct amplitude limitation and optimization processing to the first rough control quantity so as to generate the optimized precise control quantity used by the outlet valve of the circulating cooling water.

An intelligent temperature control method for the sand and dust environmental testing system is provided by the present invention, comprising:

Step 1, Build a Neural Network System Structure

The present invention adopts the three-layer feed-forward network structure with a single hidden layer; the transformation function of the hidden layer unit uses the positive-negative symmetrical Sigmoid function, a non-negative and nonlinear attenuation function partially distributed and radially symmetrical to the center. The mapping of the neural network from the input space to the hidden layer space is nonlinear, while the mapping from the hidden layer space to the output layer space is linear. In this way, the neural network realizes the characteristic of accelerating learning speed and avoids the problems of certain vibration and local minimum value, as shown in FIG. 13, wherein the three-layer feed forward network comprises:

1) Input layer

The input layer uses three special inputs respectively corresponding to the input of v (wind speed value), obtained through the wind speed sensor configured in the circulating air duct; the error e_{c} (temperature error), obtained by means of subtraction operation after getting the temperature value through the temperature sensor configured in the circulating air duct; and the constant 1, which plays a disturbance role, then the input mode vector is x=[v,e_{c},1], which, comparing with the two-input vector structure x=[v,e_{c}], is more compliant with the actual working environment.

2) Hidden layer

3) Output layer: the output of the output layer corresponds to the coordination control factor Z_{cv}, and determines which equipment is the main control equipment and which is the auxiliary control equipment.

Step 2, Blended Learning Training of the Neural Network Parameters

On the basis of the neural network model built in Step 1, the blended learning training is conducted in an online training method in combination with off-line training. Following a beforehand judgment, the conduction of the Back Propagation (BP) off-line training or the genetic algorithm-based online training can be determined.

Step 3, PI control

After obtaining the coordination control factor according to Step 1 and Step 2, input the coordination control factor to the PI controller, which will conduct further operation and combination to the coordination control factor and its parameters, so as to finally get the control variable to control the controlled mechanism.

Step 4, Amplitude Limitation Processing

After getting the control variable through Step 3, conduct amplitude limitation processing by using an S-type function to optimize the control variable.

As in Step 2, conduction of the judgment module is required before conducting the blended learning training of the neural network parameters. When the temperature difference is more favorable than the threshold value regulated, the off-line dynamic temperature model learning and training based on the BP learning algorithm will be conducted to realize the off-line global optimization of the weight and decrease the error so as to shorten the time required by the online learning; on the contrary, when the temperature difference is within the threshold value, the online adjustment will be conducted by means of genetic algorithm to optimize the weight.

Wherein, use the neural network controller to get a coordination control factor according to the wind speed value; according to the coordination control factor, determine one of at least two temperature control mechanisms to be a main control mechanism and other control mechanisms of at least two temperature mechanisms to be auxiliary mechanisms. Use the PI controller to obtain the rough control quantity, according to the temperature value and the coordination control factor.

The advantages of the present invention are as follows: 1) comparing with the traditional sand and dust blow-off environmental testing devices, without the big and small air-conditioning boxes in the present invention, the impact on the airflow quantity in the circulating air duct caused by the ventilating return passage of the air-conditioning box is eliminated, the structure is simplified and the occupied space is reduced; 2) without the surface cooler and electric heater accommodated in the air-conditioning box in the present invention, the inconvenience caused by cleaning the dust accumulated and the impact on heat transfer caused by the dust accumulation are eliminated; 3) the present invention adds a circulating hot-water system on the basis of the traditional cooling water system, which changes the traditional cooling system into a cooling-heating multipurpose temperature control system. As a result, the equipment utilization rate is enhanced; 4) electric heating sheets, capable of accelerating the heating speed of the airflow in the circulating air duct and enhancing the system's working efficiency, are respectively installed in the contraction section and a group of guide vanes in front of the contraction section in the present section; 5) in the present invention, distribute heat exchange pipes in the U-type separators, renovate the three groups of guide vanes left and configure through-holes in the interior of each guide vane; then, connect the heat exchange pipes and through-holes with the cooling-heating temperature control system, thus adequately taking advantage of the existing equipment and enhancing the equipment utilization rate. More importantly, the heat exchange space is increased and the heat exchange is further accelerated.

### BRIEF DESCRIPTION OF THE SEVERAL VIEWS OF THE DRAWINGS

FIG. 1 is the schematic view of the connection of the sand and dust environmental testing system in the prior art.

FIG. 2 is the schematic view of the aerodynamic layout structure of the circulating air duct in the present invention.

FIG. 3 is the section view of the circulating air duct in the present invention.

FIG. 4A is the axonometric view of the U-type separators with heat exchange function in the present invention.

FIG. 4B is the section view of the U-type separators with heat exchange function in the present invention.

FIG. 5A is the axonometric view of the guide vanes with heat exchange function in the present invention.

FIG. 5B is the section view of the guide vanes with heat exchange function in the present invention.

FIG. 6 is the partial section view of the circulating air duct in the present invention.

FIG. 7 is the section view of the guide vanes with heating exchange function in the present invention.

FIG. 8 is the schematic view of the temperature-adjusting device for the sand and dust environmental testing system in the present invention.

FIG. 9 is the schematic view of the routine temperature control system in the present invention.

FIG. 10 is the general flow chart of the sand and dust environment wind tunnel test system in the present invention.

FIG. 11 is the control flow chart of the intelligent wind tunnel temperature control for the sand and dust environmental test in the present invention.

FIG. 12 is the schematic view of the structure of the neural network PI control-based intelligent wind tunnel temperature control for the sand and dust control environmental test in the present invention.

FIG. 13 is the structural view of the neural network controller of the intelligent wind tunnel temperature control for the sand and dust environmental test in the present invention.

FIG. 14 is structural view of the blended learning training algorithm-based neural network PI control of the intelligent wind tunnel temperature control for the sand and dust environmental test in the present invention.

FIG. 15 is the general flow chart of the learning training algorithm of the intelligent wind tunnel temperature control system based on the neural network PI control for the sand and dust environmental test in the present invention.

FIG. 16 is the flow chart of the improved BP learning algorithm of the intelligent wind tunnel temperature control for the sand and dust environmental test in the present invention.

Wherein: 1. circulating air duct 101. test section 102. diffusion section 103. separation section
104. the first corner section 105. the first contraction section 106. the second corner section 107. square-to-round transition 108. power section
109. round-to-square transition 110. variable cross section 111. the third corner section 112. the fourth corner section 113. stabilization section
114. the second contraction section 1141. electric heater 115. the first guide vane 116. the second guide vane
117. the third guide vane 118. the fourth guide vane 1181. insulation layer 1182. wear-proof protection layer
1183. electric heater 119. heat exchange medium through-hole 2 big air-conditioner 3. small air-conditioner 4. finned pipe of surface cooler
5. fin-type electric heater 6. variable-frequency & speed-regulation air-conditioner 7. inlet duct of the big air-conditioner 8. inlet duct of the small air-conditioner
9. return-air duct of air-conditioner 10. water source of cold-water unit 11. dust-blowing duct of the big air-conditioner 12. dust-blowing duct of the small air-conditioner
13. main blower 14. air cooler 15. rectification grid 16. water source of circular cooling water
161. outlet duct of circular cooling water 162. return-water duct of circular cooling water 163. outlet valve of circular cooling water 164. return-water valve of circulating water 17. cold-water unit 171 outlet duct of the cold-water unit 172. return-water duct of the cold-water unit 173. outlet control valve of the cold-water unit 174. return-water control valve of the cold-water unit
18. electric boiler 181. outlet duct of the electric boiler 182. return-water duct of the electric boiler 183. outlet control valve of the electric boiler 184. return-water control valve of the electric boiler 19. U-type separators 191. heat exchange pipe 192. U-type part 193. angle steel fixer
e(t): precise quantity of temperature deviation e_{c}: precise quantity of the error variation rate
r(t): temperature input value y(t): output value of the controlled temperature quantity
W: connection weight between each layer Z_{cv}: coordination control factor
V; wind speed value
101: temperature sensor 102: the first PI controller
106: wind speed sensor 107: neural network controller
108: the first amplitude limiter 109: the second PI controller
110: the second amplitude limiter

### DETAILED DESCRIPTION OF THE INVENTION

A further detailed description of the technical scheme of the present invention will be given hereinafter in combination with the drawings.

The sand and dust blowing environmental testing equipment generally comprises a circulating air duct, a compressed air source, a sand and dust material system, a temperature control system, a humidity control system and an air duct pressure control system, wherein the circulating air duct is used to provide the place for the test piece in the sand and dust blowing environment; the compressed air source and the sand and dust material system (not shown in the figures) are used to realize the concentration of the experiment environment; the temperature control system, humidity control system and the air duct pressure control system form the air-conditioning system and connect with each other through the circulating air duct and pipes, which are configured with several valves for effectively adjusting the flow quantity of the sand and dust, the air force, the pressure, the humidity and the temperature.

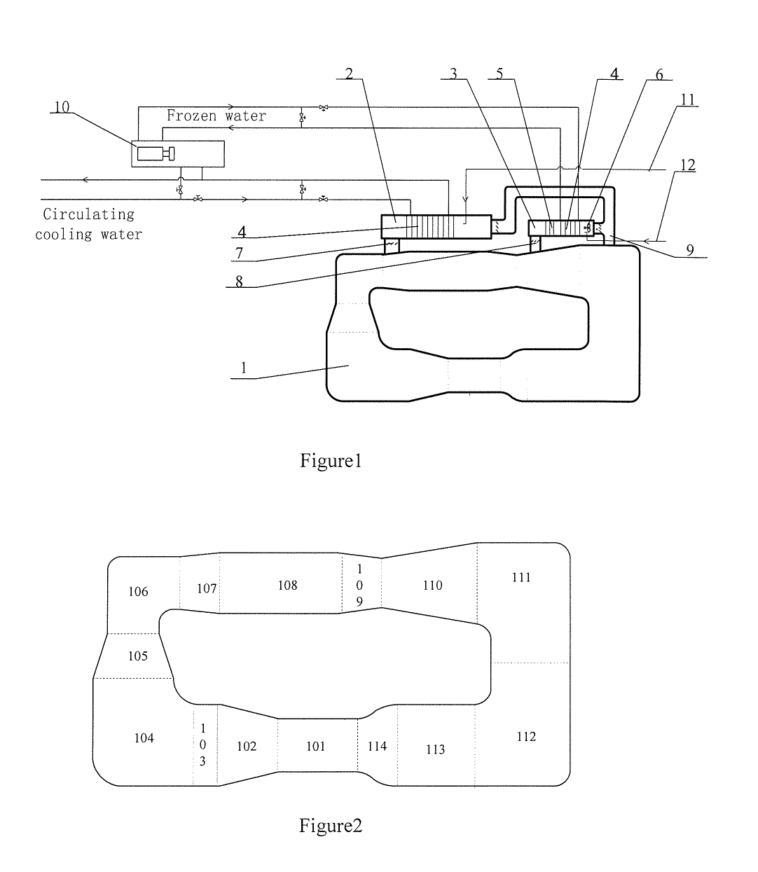

FIG. 2 shows the schematic view of the aerodynamic layout of the circulating air duct in the present invention. According to its different structural sections, the circulating duct 1 is divided into test section 101, diffusion section 102, separation section 103, the first corner section 104, the first contraction section 105, the second corner section 106, square-to-round transition section 107, power section 108, round-to-square transition section 109, variable cross section 110, the third corner section 111, the fourth corner section 112, stabilization section 113 and the second contraction section 114.

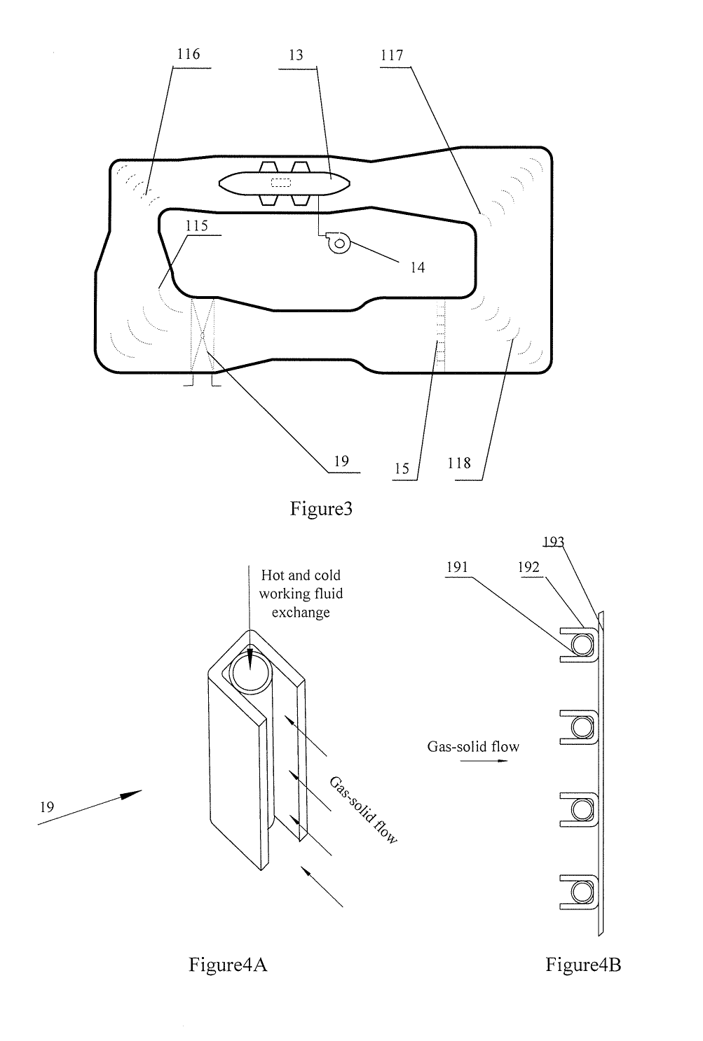

As shown in FIG. 3, the first guide vane 115, the second guide vane 116, the third guide vane 117 and the fourth guide vane 118 are respectively configured in the four corner sections 104, 106, 111 and 112; the main blower 13, equipped with an air cooler 14 for cooling it on the exterior, is accommodated in the power section 108; a honeycomb-structure rectification grid 15 is accommodated in the stabilization section 113.

FIG. 4A and FIG. 4B show the axonometric view and section view of the multifunctional U-type separators 19 configured in the separation section 103 in the present invention, wherein the U-type separators are formed by a U-type part 192, an angle steel fixer 193 and a heat exchange pipe 191. The U-type part 192 is spot-welded to the angle steel 193 and the heat exchange pipe 191 is soldered to the bottom of the internal side of the U-type part 192. In this way, the separators with heat exchange function are realized.

Wherein, the heat exchange pipes use seamless steel pipes or welded steel pipes.

FIG. 5A and FIG. 5B show the axonometric view and section view of the guide vanes 115, 116 and 117 configured at the corners 104, 106 and 111 of the circulating air duct in the present invention. Take 115 as an example, through reserving a heat exchange through-hole 119 in the interior of the cambered streamline-type guide vane and injecting heat exchange medium into the heat exchange hole 119, the guide vane with heat exchange function is realized.

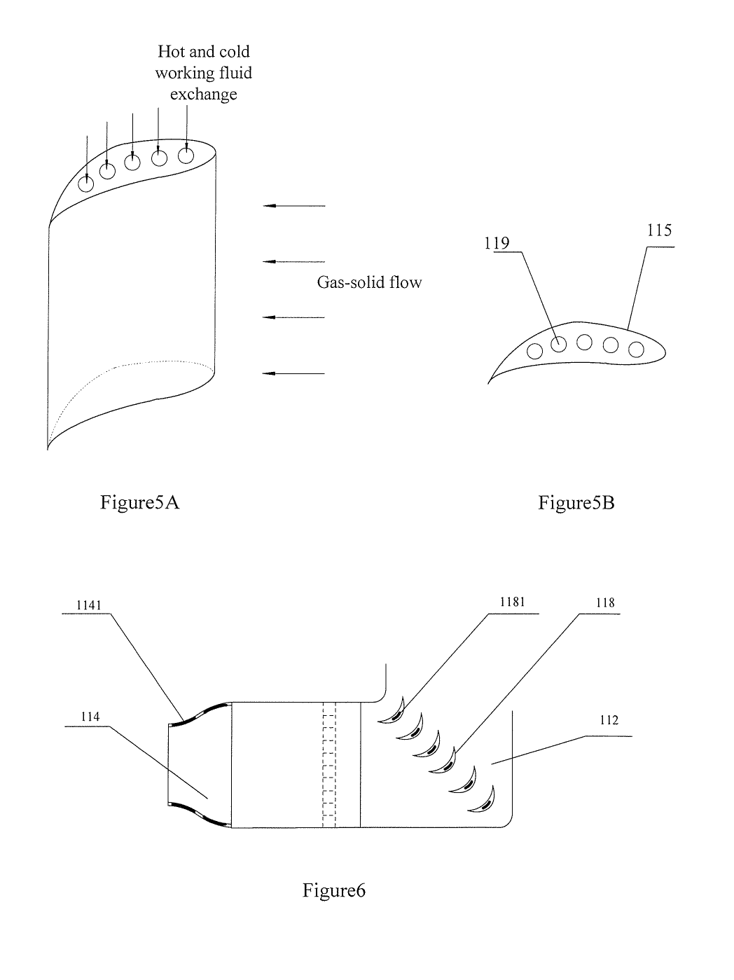

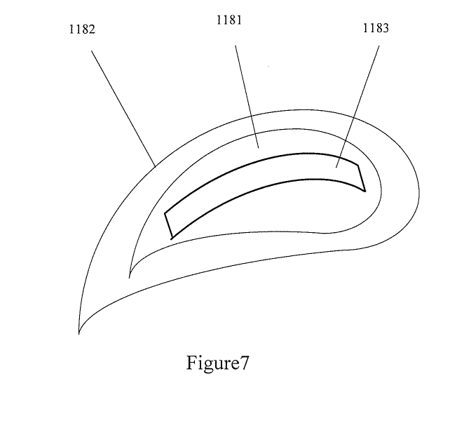

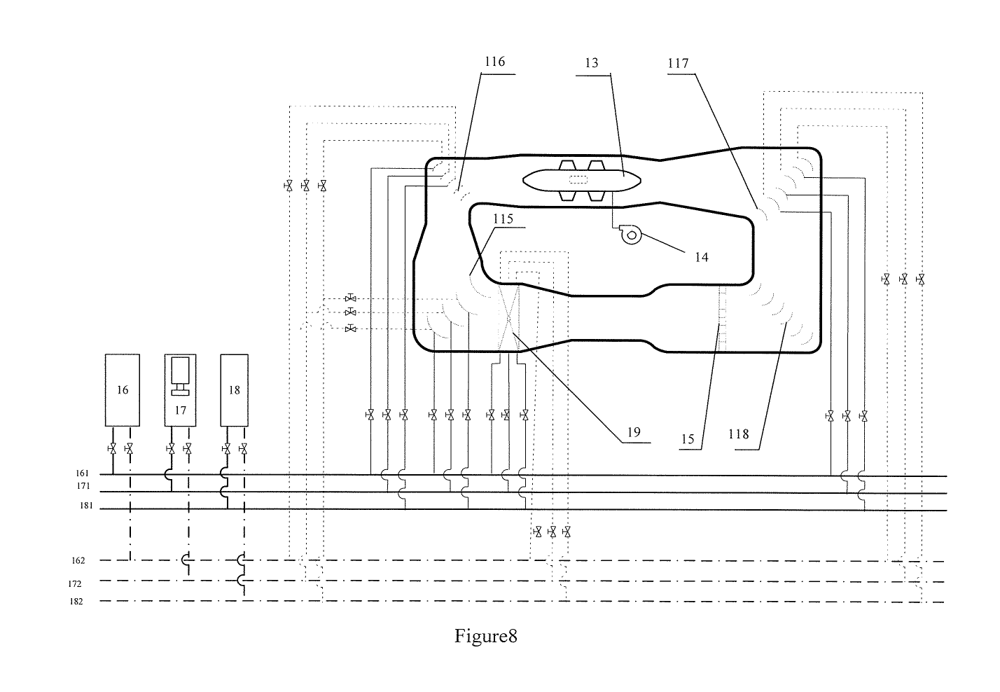

As shown in FIG. 6, the rapid, highly efficient and sensitive temperature control is realized through the temperature sensor connected with the electric heater 1183, wherein the electric heater 1183 is inserted in the fourth guide vane 118 configured in the corner section 112 of the circulating air duct.

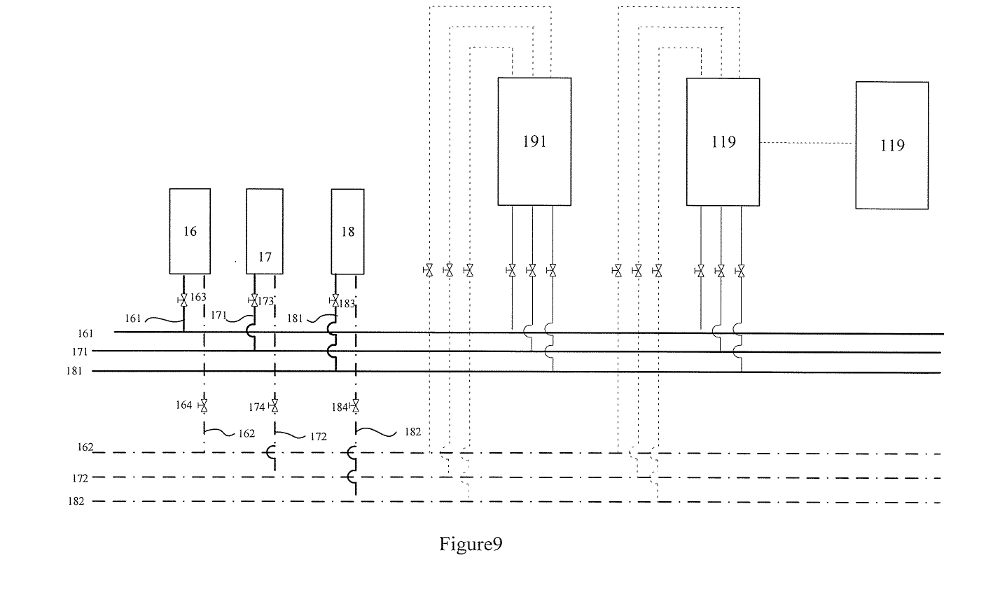

FIG. 7 shows the section view of the fourth guide vane 118 in the present invention, the electric heater 1183 configured in the interior of the guide vane 118 is coated with an insulation layer 1181 for electric heater and a wear-proof protection layer 1182, in turn. By inserting an electric heater 1183 connected with the temperature sensor in its interior, the fourth guide vane 118 can realize the rapid and uniform heating of the airflow in the circulating air duct on the basis of the realization of airflow guiding function.

Wherein, the insulation layer 1181 for electric heater uses thermally conductive silicone, which is a kind of insulation material with excellent thermal conductivity.

As shown in FIG. 6, the rapid, highly efficient and sensitive temperature control is realized through the temperature sensor connected with the electric heater 1141 which is distributed in the contraction section 114 of the circulating air duct.

The electric heater 1183 configured in the fourth guide vane 118 above is used to conduct rapid and uniform heating of the airflow in the circulating air duct in combination with the electric heater 1141 configured in the contraction section 114.

As shown in FIG. 8, the temperature control device of the present invention is provided with heat exchange media with different temperatures by three devices: a water source 16 of the circular cooling water, a cold-water unit 17 and an electric boiler 18. The three heat exchange medium sources with different temperatures are connected with a manual valve in parallel through pipes, the routine temperature control system is formed through the communication between the U-type separators 19 with heat exchange function and the guide vanes 115-117 with heat exchange functions in the circulating air duct and the pipes. The airflow quantity control is then realized through the adjusting valves on their respective pipelines, thus realizing the airflow temperature control in the circulating air duct; an electric heater is configured in the interior of the contraction section 114, wherein the contraction section 114 is located upstream of the air duct of the test section 101 and influences the test section 101 most directly. Thus, the heating effect is most obvious. An electric heater 20 is inserted in the guide vane 118, which is configured in the corner section 112. The two groups of electric heaters form a rapid heating system capable of realizing the rapid heating of the airflow in the circulating air duct at the two nearest places in front of the test section 101, thus enhancing the heating speed and heat-utilization rate.

FIG. 9 shows the schematic view of the routine temperature control system in the present invention. The temperature adjusting system medium is provided by the circular cooling water 16, cold-water unit 17 and electric boiler 18, and adopts cooling-heating multipurpose temperature control mode. The circular cooling water is connected with the heat pipe of the U-type separators 19 and the through-holes of the guide vanes 115-117 through special pipes, the cooling water flow quantity is controlled through the outlet valve 163 configured on the outlet duct 161 of the circular cooling water and the return-water valve 164, configured on the return-water duct 162 of the circular cooling water during the test; the flow quantity of the chilled water flowing out from the cold-water unit 17 during the test is controlled through the outlet control valve 173, configured on the outlet duct 171 of the cold-water unit, and the return-water control valve 174, configured on the return-water duct 172 of the cold-water unit; the flow quantity of the circulating water heated in the electric boiler 18 is controlled through the outlet control valve 183, configured on the outlet duct 181 of the electric boiler, and the return-water control valve 184, configured on the return-water duct 182 of the electric boiler.

Wherein, the cooling medium of the cold-water unit 17 is provided by the water source 16 of the circular cooling water, and the electric boiler chooses proper power according to the actual situation.

The principles of the present invention are: the circular cooling water, cold-water unit, circulating hot water in the electric boiler and their pipes form a cooling medium and heating medium unified-temperature-allocating network, which is connected with the heat exchange through-holes in the three groups of guide vanes as well as the heat exchange pipes located in the U-type separators. The medium in the allocating network passes through the heat exchange pipes in the U-type separators and the heat exchange through-holes in the three groups of guide vanes to exchange heat with the airflow in the circulating air duct, thus realizing the temperature adjustment in the circulating air duct. The cooling medium and heating medium unified-temperature-allocating network controls and changes the flow quantity of the medium in the heat exchange pipes of the U-type separators and the heat exchange medium through-holes in the guide vanes through several valves configured on the adjusting channel, so as to realize the automatic temperature control. Electric heaters are installed in the contraction section, the guide vane is configured at the corner in front of the contraction section, and the closed-loop control is conducted to the electric heaters through the temperature signal configured in the test section to rapidly change the output heat of the electric heaters. The two groups of electric heaters form a rapid heating system for the airflow in the circulating air duct. The whole temperature-adjusting device for the circulating air duct is formed by the heat exchange of the medium and the heat output of the electric heater.

The working process of the present invention will be described hereinafter.

As shown in FIG. 8, under the driving of the main blower 13, the air tested flows circularly in the circulating air duct 1 to form a test wind speed fulfilling the experiment requirements in the test section 101 of the circulating air duct. Wherein the sand blowing speed is 18˜30 m/s, the low-speed dust blowing is 1.5 m/s, the high-speed dust blowing is 8.9 m/s and the wind speed can be controlled by means of closed loop control through adjusting the rotation speed of the main blower 13. The aerodynamic layout of the circulating air duct 1 is as shown in FIG. 2. To reduce the resistance loss in the circulating air duct 1, four groups of guide vanes 115-118 are configured at the four corners of the circulating air duct; to improve the airflow quality in the test section 101, the second contraction section 114 and a stabilization section 113 are configured upstream of the test section 101, wherein a rectification grid 16 is accommodated in the stabilization section 113 to reduce the turbulence intensity of the test section 101; to avoid the damage to the main blower 13 caused by large-diameter sand and dust grains, a diffusion section 102 and separation section 103 are configured at the outlet of the test section 101, wherein four rows of U-type separators 19 are alternately installed in the separation section 103 facing the wind, and the diffusion section 102 is configured between the test section 101 and the separation section 103 to reduce the wind speed at the inlet cross section of the separation section 103, thus improving the air-solid separation efficiency of the separation section 103.

The routine temperature control in the circulating air duct is realized by the U-type separators 19 with a heat exchange function, which is configured in the separation section 103, and the three groups of guide vanes 115-117 with heat exchange function, which are configured at the corners 104, 106, 111 of the circulating air duct. The adjusted variable is the temperature of the test section 101. The outlet temperature of the circular cooling water is 35° C., which is used to balance the system heat load of the test section 101 during the high-temperature sand blowing test with a required temperature of 70° C. The outlet temperature of the cold-water unit 17 is 7° C., which is used to balance the system heat load during the normal-temperature sand blowing (23° C.) and high-temperature dust blowing (70° C.) tests. The outlet temperature of the electric boiler is 90° C., which is used to heat the airflow in the circulating air duct 1 rapidly so that the test section 101 can reach the preset state rapidly. When conducting the test, first detect whether the temperature of the test section 101 meets the expected test requirements. If the temperature is lower than the expected temperature, the control valves 163 and 164 on the outlet and return-water ducts of the circular cooling water and the control valves 173 and 174 on the outlet and return-water ducts of the cold-water unit 17 will be turned off and the adjusting valves 183 and 184 on the outlet and return-water ducts of the electric boiler will be adjusted remotely and manually, thus adjusting the hot water flow quantity in the heat exchange medium through-holes 119 of the guide vanes and the heat exchange pipes 191 of the U-type separators 19, which are configured in the circulating air duct 1, so as to adjust the airflow temperature in the circulating air duct; if the temperature of the test section is higher than the expected temperature, the control valves 183 and 184 on the outlet and return-water ducts of the electric boiler will be turned off and the adjusting valves 163 and 164 of the outlet and return-water ducts of the circular cooling water will be adjusted remotely and manually to adjust the cooling water flow quantity of the heat exchange medium through-holes 119 of the guide vanes and the heat exchange pipes 191 of the U-type separators, which are configured in the circulating air duct 1. Moreover, the adjusting valves 173 and 174 of the outlet and return-water ducts of the cold-water unit 17 can be adjusted remotely and manually to adjust the chilled water flow quantity in the heat exchange medium through-holes 119 of the guide vanes and the heat exchange pipes 191 of the U-type separators, which are configured in the circulating air duct 1.

The rapid temperature-control system in the circulating air duct 1 is controlled by the electric heater 1141, installed on the internal surface of the contraction section 114, and the electric heater 1183, accommodated in the fourth guide vane 118 with heat exchange function and located in the interior of the corner 112 of the circulating air duct. The adjusted variable of the system is the temperature of the test section 101. The test requirement for the temperature of the test section 101 is fulfilled by automatically adjusting the power of the electric heater by means of automatic closed-loop adjustment according to the temperature signal feedback of the test section 101.

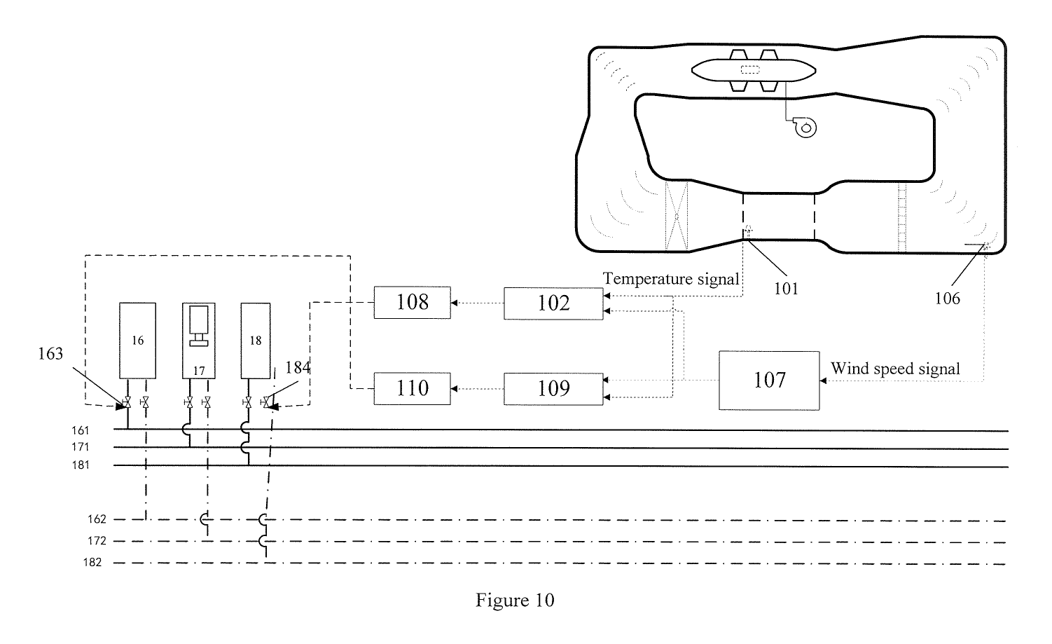

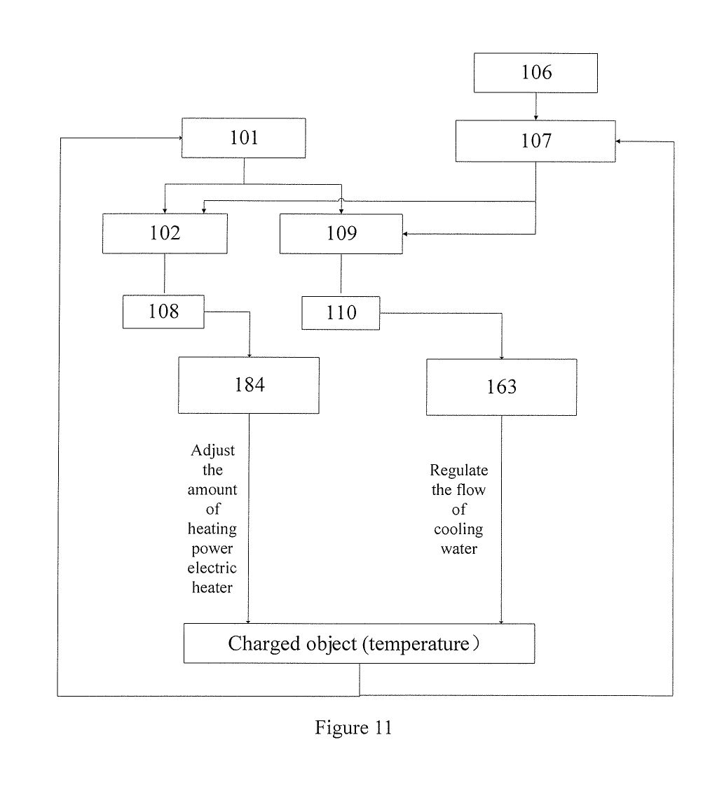

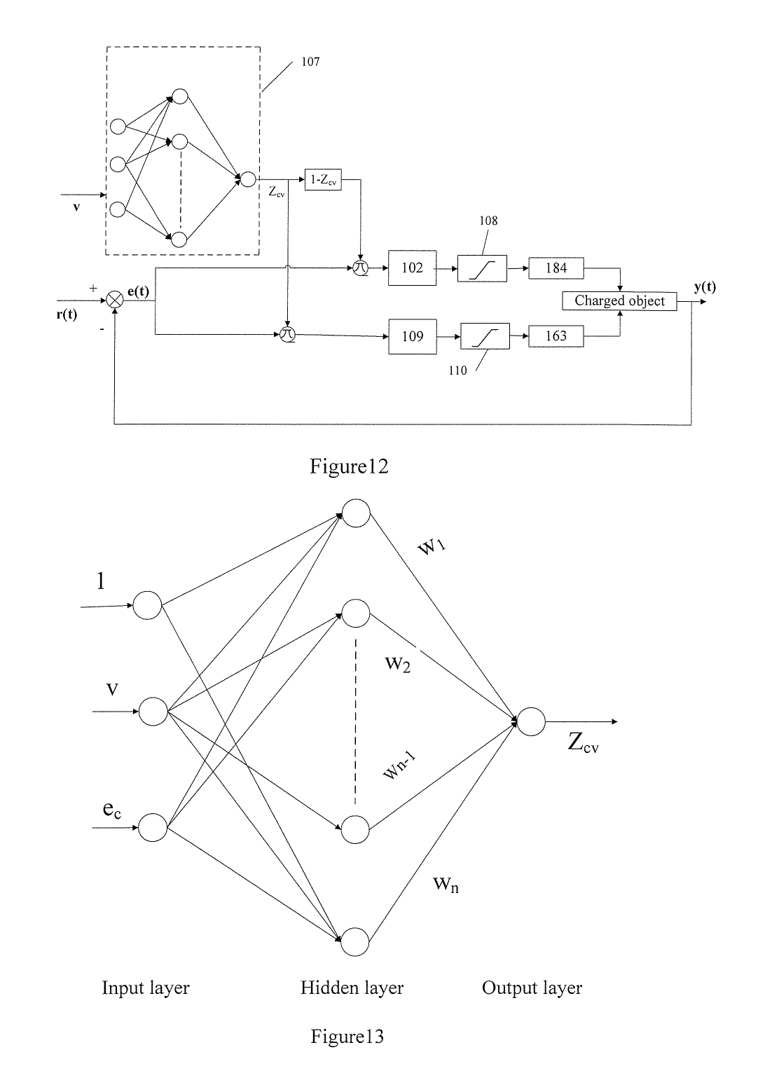

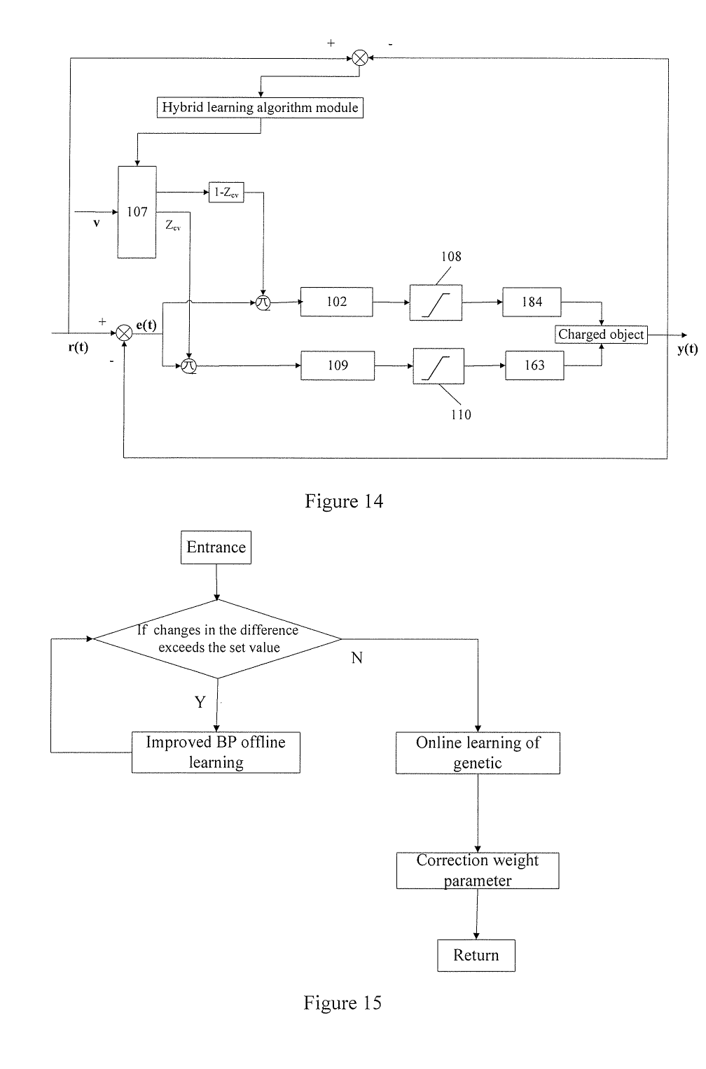

As shown in FIG. 10 and FIG. 11, an intelligent temperature-control method for the sand and dust environmental testing system is realized through a neural network-based PI intelligent temperature-control system, wherein the intelligent temperature-control system comprises:

a wind speed sensor 106, accommodated in the circulating air duct 1,

a temperature sensor 101, accommodated in the circulating air duct 1,

a neural network controller 107, which obtains a coordination control factor according to the wind speed value measured by the wind speed sensor 106 to determine which equipment is the main control equipment and which is the auxiliary equipment to fulfill the coordination control adequately. Wherein the neural network controller specifically comprises an input layer, a hidden layer and an output layer; and

a PI controller, used to receive the coordination control factor from the neural network controller and the temperature value, measured by the temperature sensor, and to transmit the control quantity processed to the temperature control device of the sand and dust environmental testing system.

Wherein the PI controller comprises:

the first PI controller 102, used to generate the first rough control quantity according to the temperature value and the coordination control factor, and

the second PI controller 109, used to generate the second rough control quantity according to the temperature value and the coordination control factor.

Wherein the intelligent temperature control system further comprises:

the first amplitude limiter 108, used to conduct amplitude limitation and optimization processing to the first rough control quantity to generate the optimized precise control quantity used by the return-water control valve 184 of the electric boiler, and

the second amplitude limiter 110, used to conduct amplitude limitation and optimization processing to the first rough control quantity to generate the optimized precise control quantity used by the outlet valve 163 of the circulating cooling water.

An intelligent temperature control method for the sand and dust environmental testing system provided by the present invention, wherein, comprising the following steps:

Step 1, Build a Neural Network System Structure

The neural network, according to a specific embodiment of the present invention, adopts the three-layer feed-forward network structure with a single hidden layer; the transformation function of the hidden layer unit uses the positive-negative symmetrical Sigmoid function, a non-negative and nonlinear attenuation function partially distributed and radially symmetrical to the center. The mapping of the neural network from the input space to the hidden layer space is nonlinear, while the mapping from the hidden layer space to the output layer space is linear. In this way, the neural network realizes the characteristic of accelerating learning speed and avoids the problems of certain vibration and local minimum value, as shown in FIG. 13.

1) Input Layer

The input layer uses three special inputs respectively corresponding to the inputs of v (wind speed value), error e_{c} (temperature error) and constant 1, which play a disturbance role herein. The input mode vector is then x=[v,e_{c},1], which is more compliant with the actual working environment compared to the two-input vector structure x=[v,e_{c}].

The function of the neuron output/input of the input layer is:

Oᵢ=x(i) (1)

Wherein i refers to the number of the neurons on the input layer, and i=1,2,3

2) Hidden Layer

The neuron output of the hidden layer is:

$${net}_{j} ( k ) = {\sum }_{i = 1}^{3} {w}_{ji} {O}_{i} \qquad ( 2 )$$

wherein wⱼᵢ refers to the weight from the input layer to the hidden layer.

The neuron output of the hidden layer is:

Oⱼ(k)=f(netⱼ(k)) (3)

wherein j refers to the number of the neurons on the hidden layer, f refers to the activation function of the hidden layer.

The activation function of the hidden layer uses the positive-negative symmetrical Sigmoid function:

$$f ( x ) = tanh ( x ) = \frac{exp ( x ) - exp ( - x )}{exp ( x ) + exp ( - x )} \qquad ( 4 )$$

3) Output Layer

The neuron output of the output layer is:

$${net}_{l} ( k ) = {\sum }_{j = 1}^{n} {w}_{ij} {O}_{j} ( k ) \qquad ( 5 )$$

wherein wᵢⱼ refers to the weight from the hidden layer to the output layer.

The neuron output of the output layer is:

Oₗ(k)=g(netₗ(k)) (6)

wherein,

$$g ( x ) = \frac{1}{2} ( 1 + tanh ( x ) ) = \frac{exp ( x )}{exp ( x ) + exp ( - x )} \qquad ( 7 )$$

The neuron output of the output layer corresponds to the coordination control factor Z_{cv}, which is determined.

Step 2, Blended Learning Training of Neural Network Parameters

On the basis of the neural network model above, the blended learning training is conducted in an online training method in combination with the off-line training. After judging in advance, the conduction of the BP algorithm-based off-line training or the genetic algorithm-based online training will be determined.

In the blended learning algorithm, the BP algorithm, which is improved continuously, conducts off-line revisions to the weight and threshold between the network neurons, thus making the network approach the real model constantly. The online genetic learning training algorithm is used to overcome several limitations of the BP off-line learning training. Since the genetic learning training algorithm applies a high-dimensional solution space to generating several starting points randomly, starts searching at the same time, and guides the search direction by means of a fitness function during the optimization, the search area is large and the search efficient is high. Moreover, during real-time control, the judgment that whether the temperature difference is too great shall be conducted before the online adjustment of the weight parameters. If it surpasses the regulated limitation value, the off-line model learning training will be conducted first until the difference is within the limit, then conduct the online learning training, thus reducing the vibration and shortening the control time, as shown in FIG. 15.

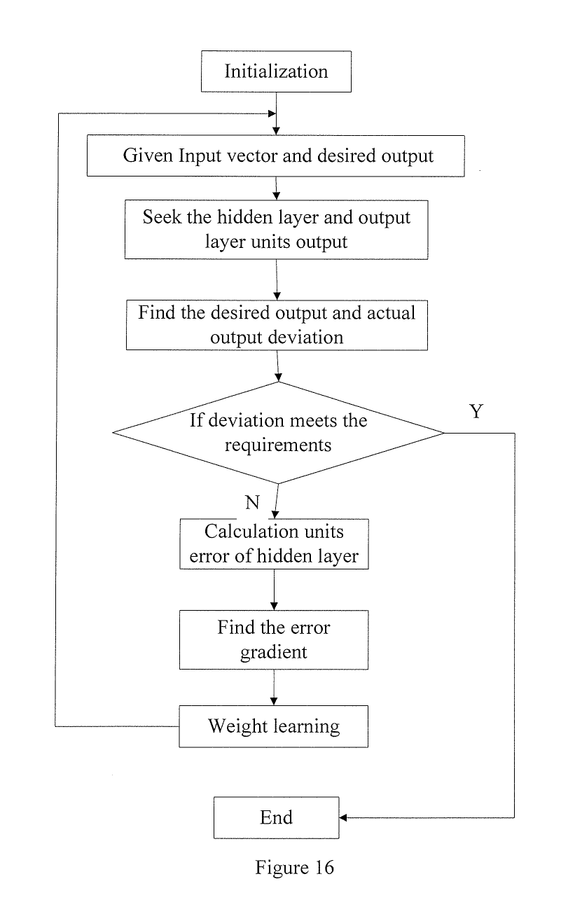

Since the Back Propagation (BP) algorithm features a simple, easy-learning rapidly converging rate, it is widely used in the adjustment of network weight. However, when being used in real-time control, as the learning rate of the BP algorithm is slow, it may get into the defect of local minimum and may fail to achieve the global optimization. This is because the large initial value error is liable to cause the over adjustment when the network is changed from one training sample to another one. This may increase the adjusting time. Therefore, according to one embodiment of the present invention, a momentum factor a is introduced to reduce the overshoot, which is in favor of the off-line learning acceleration. As shown in FIG. 16, the processing from the input layer to the hidden layer unit until the output layer after the initialization of the dynamic model is the function of input and weight. Work out the output of each unit of the hidden layer and the output layer and the deviation between the expected output and the actual output, and then judge the deviation. If deviation between the actual output and the expected output exists, the back propagation will be conducted by reversing the original forward propagation route, then calculate the hidden layer unit error and carrying out a solution along the negative gradient direction of the error function. Afterward, revise the weight coefficient of the neurons on each layer, thus minimizing the expected error function. The momentum factor a is a weighted factor determining the past learning effect, which, assuming the scale of another variation coefficient η corresponding to 0<a<1, is 0<η<0.5. At this time, the effect is fairly ideal. In addition, the two factors will be adjusted and revised constantly after each iteration. Taking the coupling effect between each variable into consideration, the performance index function is taken as:

J=E(k)=(Z′_{cv}−Z″_{cv})+½Σ[r(k)−y(k)]² (8)

The revision formula of the weight is finally obtained, which is:

ΔW_{ij,(j-1)p}^{k}=−η(k)·δᵢⱼ(k)u₍ⱼ₋₁₎ₚ^{k}+a(k)[Δ^{W}_{ij,(j-1)p}^{k}] (9)

$${δ}_{ij} ( k ) = {u}_{ij} ( k ) [ 1 - {u}_{ij} ( k ) ] {\sum }_{p = 1}^{N ( i - 1 )} {δ}_{( i - 1 ) p} \cdot {W}_{ij , ( i - 1 ) p}^{k} \qquad ( 10 )$$

After adjusting the weight by mean of the off-line learning above, a certain difference from the actual parameters may be generated. Therefore, conduct the online revision of the network weight parameters obtained in real time by means of a genetic algorithm and implement the searching process, based on the original parameters, in a comparatively smaller area of the original parameters.

The genetic algorithm is a searching algorithm based on natural selection and a population genetic system. It simulates the multiplication, mating and variation phenomena during the natural selection and heredity processes, regards each possible solution as an individual in the population, encodes each individual to the form of character string, and evaluates each individual according to the preset objective function to give a fitness value. The fitness value of the individuals conducts genetic operations through the use of genetic operators to the individuals so as to reserve the excellent individuals and eliminate the bad ones. This makes the final weight developed towards an excellent state. Herein, the traditional binary encoding is adopted. However, when the scope of the neural network is large, the individual chromosome will be long, so the efficient of the genetic algorithm is affected. Therefore, the float encoding is adopted in the present intelligent system, wherein the float encoding uses the true value of the decision variable, and the encoding length of the individual equals the number of its decision variable. In this system, there are 24 neural network weight variables, and the inverse of the error sum of squares is regarded as the fitness function. With respect to genetic operation, the selection algorithm in the genetic operation adopts a standard geometric sequencing mode which sequences the individuals according to the fitted value and distributes the choice probability according to the positions of the individuals. The choice probability formula of the individuals, which is defined by the standard geometric sequencing, is:

$${P}_{i} = \frac{q}{1 - {( 1 - q )}^{n}} {( 1 - q )}^{r - 1} \qquad ( 11 )$$

Wherein q refers to the choice of the best individual, r refers to the serial number of the individual, and n refers to the size of the population.

With respect to float encoding, the crossover algorithm adopts math crossover in combination with heuristic crossover, which can increase the detection capacity of the algorithm. To maintain the population diversity and prevent prematurity, a random disturbance shall be exerted to the genes in the original population. The mutation operation in this system uses the “multiNonUnJfMutafion” strategy to generate mutant genes in order to form a new population. After respectively conducting NonUnJfMutafion to the independent variables in their solution space, the mutation operation randomly selects one combination to be the mutation result. The principle formula is:

X′ᵢ=Xᵢ+(b₋−Xᵢ)f(g), r₁<0.5

X′ᵢ=Xᵢ−(Xᵢ−a)f(g), r₁≧0.5 (12)
wherein:

$$f ( g ) = {( {r}_{2} ( 1 - \frac{g}{{g}_{m ax}} ) )}^{b} \qquad ( 13 )$$

r₁, and r₂ refer to the uniform random variable between [0,1], aᵢ, and bᵢ respectively refer to the upper and lower limits of the variable, g refers to the current optimized algebra, gₘₐₓ refers to the maximum optimized algebra, and b refers to the system parameter used to measure the disturbance degree.

On the basis of the description above, the training steps that use the genetic algorithm to conduct the online optimization of the neural network weight coefficient are obtained as follows:
\textcircled{1} give the input and output sets of the neural network;
\textcircled{2} determine the encoding method of the network weight coefficient, select the genetic operation and set the genetic parameters;
\textcircled{3} generate an initial population through the set population size N;
\textcircled{4} decode each individual string in the population to work out N groups of network weight coefficients, thus obtaining N networks with the same structure;
\textcircled{5} use the input sample set to work out the N networks corresponding to the N groups of network weight coefficients by means of a forward propagation algorithm;
\textcircled{6} set the network object function and transform it into fitness to evaluate the N networks;
\textcircled{7} conduct selection operations in the genetic space according to the fitness;
\textcircled{8} conduct corresponding operations according to the selected crossover, mutation and related algorithms to obtain the newly-generation population;
\textcircled{9} return to Step \textcircled{4} until a group of optimized weight coefficients is obtained which fulfills the performance requirements.

Step 3, PI Control

After obtaining the coordination control factor, input the coordination control factor to the PI controller, which will conduct further operation and combination to the coordination control factor and its parameters, so as to finally get the control variable to coordinately and effectively control the controlled mechanism.

According to an embodiment of the present invention, the control equation of the circular cooling water quantity is:

G_{w}=K_{cp}Z_{cv}eₜ+K_{ci}∫(Z_{cv}eₜ)dt (14)

wherein:

G_{w}: mass flow quantity of the cooling water, eₜ: temperature difference;

K_{cp}: proportionality coefficient of the water flow quantity controller of the circular cooling water;

K_{ci}: integral coefficient of the water flow quantity controller of the circular cooling water;

K_{cd}: differential coefficient of the water flow quantity controller of the circular cooling water.

The control equation of the heating power of the electric heater:

Q_{d}=Kₜₚ(1−Z_{cv})eₜKₜᵢ∫(1−Z_{cv})eₜdt (15)

wherein:

Q_{d}; heating power of the electric heater

Kₜₚ: proportionality coefficient of the electric heater controller;

Kₜᵢ: integral coefficient of the electric heater controller;

K_{td}: differential coefficient of the electric heater controller.

Step 4, Amplitude Limitation Processing

After obtaining the control variable, certain inaccuracies may be generated. Therefore, efficient amplitude limitation processing shall be conducted to the control variable to optimize it. Herein S-type function is used to conduct amplitude limitation processing. The formula of the S-type function:

$${λ}_{cv} = \frac{1}{1 + {e}^{- a v}} \qquad ( 16 )$$

the amplitude limitation processing formula obtained through the formula above is:

f(u)=u₂ u≧u₂

f(u)=u*λ_{cv} u₁≦u<u₂

f(u)=u₁ u<u₁ (17)

wherein:

u: control variable Q_{d} or G_{w};

u₁, u₂: amplitude limitation threshold;

f(u): the control variable processed through amplitude limitation

To sum up, the principle of the present invention: The PI controller, featuring a simple design, easy realization and high reliability, is widely used in the process control and motion control of the electromechanical, metallurgical, mechanical and chemical industries etc., and is especially applicable to the deterministic control system capable of building precise mathematical models. However, because of the disturbance of many uncertain factors, using the classic PI controller to calibrate the control system in the actual industrial process usually cannot realize an ideal control effect. While the neural network features nonlinear mapping, self-learning capacity, storage capacity distribution and processing information etc., it is combined with the PI controller. The combination herein is established on the basis of coordination control, which is different from the traditional combination. Because of the uncertainties and complexity of the coordination control, the nonlinearity and self-learning capacity are used to conduct a judgment to the coordination control before the input signals enter into the PI controller, so as to obtain a coordination control factor. This control factor is used to determine which control mechanisms among all the coordination control mechanisms are main control mechanisms and which are auxiliary mechanisms. As a result, the system not only possesses the capacity of processing inaccuracy and uncertainty, but also the capacity of coordinately controlling the stability. At the same time, the system continuously revises the connection weight of the neural network and adjusts the coordination control factor by means of self-learning capacity to make the factor be the parameter under some optimized coordination control, to fulfilling the requirements for the system performance index. The system then sends the coordination control factor into the PI controller and conducts the corresponding control operation. After the PI controller sends the signal output, corresponding amplitude limitation processing is required to conduct further precision of the control variable so as to finally realize the coordination and reliability of the intelligent temperature control for the sand and dust environmental test and reduce the fluctuation amplitude during the sand and dust temperature adjustment.

The neural network structure of the neural network PI-based intelligent temperature-control system is a three-layer network structure with a single hidden layer. The transformation function of the hidden layer unit uses the Sigmoid function, a non-negative and nonlinear attenuation function which is partially distributed and radially symmetrical to the center, in radial basis function. The mapping of the neural network from the input space to the hidden layer space is nonlinear, while the mapping from the hidden layer space to the output layer space is linear. In this way, the neural network realizes the characteristic of accelerating learning speed and avoiding the problems of certain vibration and local minimum value.

It shall be noted that the neural network, after learning training, can ideally adjust parameters and highly accurately approach the nonlinear function of the input & output signal of the intelligent temperature control and possesses great generalization capacity. The learning training process is such that, after the initialization, the judging module will judge whether the temperature difference surpasses a certain limit. If it surpasses the limit, off-line dynamic temperature model learning will be conducted, thus reducing the error quantity before conducting the online learning and shortening the online learning time. The parameter adjustment by means of off-line model learning is essentially the off-line weight global optimization using the improved BP algorithm. It then continues to calculate until the difference is within the limit range. Afterward, it conducts the online learning training phase. The weight parameter adjustment by means of online learning mainly randomly generates several starting points in the high dimensional solution space, starts searching at the same time, and then guides the search direction through fitness function by means of genetic algorithms, thus obtaining the optimized weight parameter.

According to an embodiment of the present invention when defining the off-line learning, the dynamic model of the used expert system will be:

$${M}_{t} {c}_{t} \frac{d {θ}_{t}}{d t} = {k}_{h} {n}_{f}^{3} + {G}_{a} {c}_{a} ( {θ}_{a} - {θ}_{t} ) - {k}_{s} {F}_{s} \cdot ( {θ}_{t} - {θ}_{s} ) + {Q}_{d} - {G}_{w} {c}_{w} ( {θ}_{t} + Δ {θ}_{w o} - {θ}_{wi} ) \qquad ( 18 )$$

Mₜ: equivalent metal mass in the circulating air duct

Cₜ: average specific heat capacity

n_{f}³: rotational speed of the blower in the circulating air duct

kₕ: proportionality coefficient

kₛ: heat transfer coefficient of the external surface of the circulating air duct

Fₛ: heat transfer area

θₛ, θₐ, θₜ: environment temperatures

G_{w}: mass flow of the cooling water

c_{w}, cₐ: specific heat

θ_{wi}: inlet temperature

Δθ_{wo}: outlet terminal difference of the cooling water

Gₐ: mass flow of the auxiliary air in the circulating air duct

Q_{d}: heating power of the electric heater

The present invention is capable of realizing the temperature control of the sand and dust environmental testing device system to meet the temperature conditions required by the environmental test. It not only features a simple structure and integration, but also rapid and highly efficient temperature control. It can be applied to the easy-to-clean places with compact structure where frequent tests are conducted.

1. A temperature-adjusting device for a sand and dust environmental testing system, the sand and dust environmental testing system mainly comprises comprising:
a circulating air duct, which is a closed air duct with an irregular structure for blowing sand and dust, the circulating air duct including a contraction section, a test section and a separation section;
a main blower, used to drive the airflow in the circulating air duct;
U-type separators configured on the separation section, used to conduct the separation and recycling of the sand and dust tested; and
guide vanes respectively configured at four corners of the circulating air duct in four groups;
the temperature adjusting device comprising:
heat exchange pipes distributed in the U-type separators;
the four groups of guide vanes, wherein three groups of the guide vanes are configured with heat exchange medium holes and the other group of the guide vanes is equipped with heating device; and
an electric heater accommodated in the contraction section.

2. The temperature-adjusting device for the sand and dust environmental testing system according to claim 1, is the temperature-adjusting device further comprising:
a circulating cooling water source;
a cold-water unit; and
an electric boiler;
the circulating cooling water source, the cold-water unit and the electric boiler being connected with the guide vanes and the U-type separators through respective sets of pipes; each of the respective sets of pipes including valves for adjusting flow through each of the respective sets of pipes.

3. The temperature-adjusting device for the sand and dust environmental testing system according to claim 1, wherein the heating device of in the guide vanes is an electric heater which is coated with an insulation layer and a wear-proof protection layer in turn.

4. An intelligent temperature control system for a sand and dust environmental testing system, which is realized through a neural network-based PI intelligent temperature control system, the intelligent temperature control system comprising:
a wind speed sensor accommodated in the circulating air duct;
a temperature sensor accommodated in the circulating air duct,
a neural network controller comprising an input layer, a hidden layer and an output layer; the function of the neural network controller includes a coordination control factor so as to determine which equipment is main control equipment and which is auxiliary equipment;
a PI controller, that receives an output resulting from the coordination control factor from the neural network controller and receives a temperature value measured by the temperature sensor and transmits a control quantity processed to a temperature control device for the sand and dust environmental testing system.

5. The intelligent temperature control system for the sand and dust environmental testing system, which is realized through the neural network-based PI intelligent temperature control system, according to claim 4, wherein the PI controller comprises:
a first PI controller, that generates a first rough control quantity in response to the temperature value and the coordination control factor,
a second PI controller, that generates a second rough control quantity in response to the temperature value and the coordination control factor.

6. The intelligent temperature control system for the sand and dust environmental testing system, which is realized through the neural network-based PI intelligent temperature control system according to claim 4, wherein the intelligent temperature control system further comprises:
a first amplitude limiter, that conducts amplitude limitation and optimization processing to a first rough control quantity generating an optimized precise control quantity used by a return-water control valve of an electric boiler of the sand and dust environmental testing system, and
a second amplitude limiter, that conducts amplitude limitation and optimization processing to the first rough control quantity generating the optimized precise control quantity used by the outlet valve of the circulating cooling water of the sand and dust environmental testing system.

7. An intelligent temperature control method for a sand and dust environmental testing system, comprising:
building a neural network system structure;
adopting a three-layer feed-forward network structure with a single hidden layer; a transformation function of the hidden layer unit uses a positive-negative symmetrical Sigmoid function, a non-negative and nonlinear attenuation function partially distributed and radially symmetrical to the center; mapping of a neural network from an input space to the hidden layer space being nonlinear, while the mapping from the hidden layer space to an output layer space is linear, the neural network realizing the characteristic of accelerating learning speed and avoiding problems of certain vibration and local minimum value;
the three-layer feed-forward network comprising:
1) an input layer using three special inputs respectively corresponding to inputs of v (a wind speed value), obtained through a wind speed sensor configured in the circulating air duct; an error e_{c} (temperature error), obtained by means of subtraction after getting the temperature value through the temperature sensor configured in the circulating air duct; and a constant 1, which plays a disturbance role, the input mode vector is thus x=[v,e_{c},1], which is more compliant with the actual working environment compared to the two-input vector structure x=[v,e_{c}],
the input and output function of the neuron on the input layer is:
Oᵢ=x(i) (1)
wherein i refers to the number of the neurons on the input layer, i=1,2,3
2) a hidden layer where a neuron output is:
$${net}_{j} ( k ) = {\sum }_{i = 1}^{3} {w}_{ji} {O}_{i} \qquad ( 2 )$$
wherein wᵢⱼ refers to the weight from the input layer to the hidden layer, and the neuron output of the hidden layer is:
Oⱼ(k)=f(netⱼ(k)) (3)
wherein j refers to the number of the neurons in the hidden layer, and f refers to an activation function of the hidden layer, the activation function of the hidden layer uses the positive-negative symmetrical Sigmoid function:
$$f ( x ) = tanh ( x ) = \frac{exp ( x ) - exp ( - x )}{exp ( x ) + exp ( - x )} \qquad ( 4 )$$
3) an output layer where a neuron output of the output layer is:
$${net}_{l} ( k ) = {\sum }_{j = 1}^{n} {w}_{ij} {O}_{j} ( k ) \qquad ( 5 )$$
wherein wᵢⱼ refers to the weight from the hidden layer to the output layer and the neuron output of the output layer is:
Oₗ(k)=g(netₗ(k)) (6)
$$g ( x ) = \frac{1}{2} ( 1 + tanh ( x ) ) = \frac{exp ( x )}{exp ( x ) + exp ( - x )} \qquad ( 7 )$$
a neuron output of the output layer corresponds to the coordination control factor Z_{cv}, wherein the coordination control factor determines which equipment is the main control equipment and which is the auxiliary control equipment;
blended learning training of the neural network parameters on the basis of the neural network model built in the building the neural network system structure, the blended learning training is conducted in an online training method in combination with the off-line training, after judging in advance, the conduction of BP off-line training or the genetic algorithm-based online training is determined.
PI controlling, such that after obtaining the coordination control factor according to the building the neural network system structure and the blended learning training, inputting of the coordination control factor to the PI controller, which conducts further operation and combination to the coordination control factor and its parameters so as to finally get a control variable to control a controlled mechanism.
amplitude limitation processing after getting the control variable through the PI controlling, conduct amplitude limitation processing using an S-type function to optimize the control variable.

8. The intelligent temperature control method for the sand and dust environmental testing system according to claim 7, wherein in the blended learning training, the conduction of a judgment module is required before conducting the blended learning training of the neural network parameters, when the temperature difference is more favorable than a threshold value regulated, the off-line dynamic temperature model learning and training based on a BP learning algorithm will be conducted to realize the off-line global optimization of the weight and decrease the error, shortening the time required by the online learning, and when the temperature difference is within the threshold value, the online adjustment will be conducted by means of genetic algorithm to optimize the weight.

9. The intelligent temperature control method for the sand and dust environmental testing system according to claim 7 wherein the neural network controller is used to obtain a coordination control factor according to the wind speed value; according to the coordination control factor, one of at least two temperature control mechanisms is determined to be a main control mechanism and other control mechanisms of the at least two temperature mechanisms are determined to be auxiliary mechanisms; and a PI controller is used to obtain the rough control quantity according to the temperature value and the coordination control factor.
